(19) United States
(12) Patent Application Publication
(10) Pub. No.: US 2023/0319401 A1
(43) Pub. Date: Oct. 5, 2023

(54) IMAGE CAPTURE USING DYNAMIC LENS POSITIONS

(71) Applicant: QUALCOMM Incorporated, San Diego, CA (US)

(72) Inventors: Wen-Chun FENG, New Taipei City (TW); Su-Chin CHIU, Wanhua Dist. (TW); Yu-Ren LAI, Nantou County (TW); Hang-Wei LIAW, North District (TW); Jian-Jia SU, Changhua (TW)

(21) Appl. No.: 17/710,774

(22) Filed: Mar. 31, 2022

(51) Int. Cl. H04N 5/232; G06T 7/50; G06T 5/50; G06T 7/20; G06T 5/00

(52) U.S. Cl. CPC H04N 5/23212; G06T 7/50; G06T 5/50; G06T 7/20; G06T 5/003; G06T 2207/20081; G06T 2207/30201

(57) ABSTRACT

Disclosed are systems, apparatuses, processes, and computer-readable media to capture images with subjects at different depths of fields. A method of processing image data includes determining, based on a depth map of a previously captured image, a first distance to a first object and a second distance to a second object; identifying a focal point of a camera lens at least in part using the first distance and the second distance; capturing an image using the focal point as a basis for the capture, the image including a first region corresponding to the first object and a second region corresponding to the second object; and generating a second image from the image at least in part by enhancing at least one of the first region or the second region using a point spread function (PSF).

### FIELD

The present disclosure generally relates to image processing. For example, aspects of the present disclosure relate to systems and techniques for capturing images (e.g., with subjects at different depths of fields) using dynamic lens positions.

### BACKGROUND

A camera is a device that captures images, such as still images or video frames, by receiving light through a lens and by using the lens (and sometimes one or more mirrors) to bend and focus the light onto an image sensor or a photosensitive material such as photographic film. The resulting images are captured by the image sensor and either stored on the photographic film, which can be developed into printed photographs, or stored digitally onto a secure digital (SD) card or other storage device. To capture a clear image, as opposed to a blurry image, a camera must be focused properly. Focusing a camera involves moving the lens forward and backward to ensure that light coming from an object that is the intended subject of the captured image is being properly focused onto the image sensor or photographic film. In some cameras, focus is adjusted manually by the photographer, typically via a dial along the camera that the photographer rotates clockwise or counterclockwise to move the lens forward or backward.

### SUMMARY

In some examples, systems and techniques are described for capturing images (e.g., with subjects at different depths of fields) using dynamic lens positions. According to at least one example, a method is provided for capturing an image. The method includes: determining, based on a depth map of a previously captured image, a first distance to a first object and a second distance to a second object; identifying a focal point of a camera lens at least in part using the first distance and the second distance; capturing an image using the focal point as a basis for the capture, the image including a first region corresponding to the first object and a second region corresponding to the second object; and generating a second image from the image at least in part by enhancing at least one of the first region or the second region using a point spread function (PSF).

In another example, an apparatus for capturing an image is provided that includes at least one memory and at least one processor coupled to the at least one memory. The at least one processor is configured to: determine, based on a depth map of a previously captured image, a first distance to a first object and a second distance to a second object; identify a focal point of a camera lens at least in part using the first distance and the second distance; capture an image using the focal point as a basis for the capture, the image including a first region corresponding to the first object and a second region corresponding to the second object; and generate a second image from the image at least in part by enhancing at least one of the first region or the second region using a PSF.

In another example, a non-transitory computer-readable medium is provided that has stored thereon instructions that, when executed by one or more processors, cause the one or more processors to: determine, based on a depth map of a previously captured image, a first distance to a first object and a second distance to a second object; identify a focal point of a camera lens at least in part using the first distance and the second distance; capture an image using the focal point as a basis for the capture, the image including a first region corresponding to the first object and a second region corresponding to the second object; and generate a second image from the image at least in part by enhancing at least one of the first region or the second region using a PSF.

In another example, an apparatus for capturing an image is provided. The apparatus includes: means for determining, based on a depth map of a previously captured image, a first distance to a first object and a second distance to a second object; means for identifying a focal point of a camera lens at least in part using the first distance and the second distance; means for capturing an image using the focal point as a basis for the capture, the image including a first region corresponding to the first object and a second region corresponding to the second object; and means for generating a second image from the image at least in part by enhancing at least one of the first region or the second region using a PSF.

In some aspects, one or more of the methods, apparatuses, and computer-readable medium described above further comprise: selecting the PSF based on at least one of a distance between the first object and the focal point and distance between the second object and the focal point.

In some aspects, the PSF is selected from a lookup table.

In some aspects, the lookup table is determined using a machine learning (ML) model trained using defocused images and a loss function to correct the defocused images.

In some aspects, the lookup table is determined using a computer vision-based PSF estimate determined from defocused images and an error calculation and iteratively modifying the computer vision-based PSF estimate until a minimum error is identified for each focal distance and each amount of blur.

In some aspects, one or more of the methods, apparatuses, and computer-readable medium described above further comprise: generating a modified first region at least in part by applying a deconvolution operation to the first region based on the PSF; and generating a modified second region at least in part by applying a deconvolution operation to the second region based on the PSF.

In some aspects, the first object is a face of a first person and the second object of a face of a second person.

In some aspects, one or more of the methods, apparatuses, and computer-readable medium described above further comprise: determining a first depth of field associated with the first object and a second depth of field associated with the second object; and identifying the focal point as a point between the first depth of field and the second depth of field.

In some aspects, the first depth of field is determined using a lookup table based on a depth associated with the first object, and wherein the second depth of field is determined using the lookup table based on a depth associated with the second object.

In some examples, systems and techniques are described for capturing an image. Disclosed are systems, apparatuses, methods, and computer-readable media for capturing an image. According to at least one example, a method is provided for capturing an image. The method includes: identifying a focal point of an object; capturing a first image using the focal point as a basis for the capture, the first image including a first region that is degraded due to an optical deformation; estimating a PSF based on the focal point and the optical deformation; and generating a second image from the first image at least in part by enhancing the first region of the first image using the PSF. In some aspects, the optical deformation can occur in different regions and the method may include enhancing second region of the first image using the PSF.

In another example, an apparatus for capturing an image is provided that includes at least one memory and at least one processor coupled to the at least one memory. The at least one processor is configured to: identify a focal point of an object; capture a first image using the focal point as a basis for the capture, the first image including a first region that is degraded due to an optical deformation; estimate a PSF based on the focal point and the optical deformation; and generate a second image from the first image at least in part by enhancing the first region of the first image using the PSF. In some aspects, the optical deformation can occur in different regions and the method may include enhancing a second region of the first image using the PSF.

In another example, a non-transitory computer-readable medium is provided that has stored thereon instructions that, when executed by one or more processors, cause the one or more processors to: identify a focal point of an object; capture a first image using the focal point as a basis for the capture, the first image including a first region that is degraded due to an optical deformation; estimate a PSF based on the focal point and the optical deformation; and generate a second image from the first image at least in part by enhancing the first region of the first image using the PSF. In some aspects, the optical deformation can occur in different regions and the method may include enhancing a second region of the first image using the PSF.

In another example, an apparatus for capturing an image is provided. The apparatus includes: means for identifying a focal point of an object; means for capturing a first image using the focal point as a basis for the capture, the first image including a first region that is degraded due to an optical deformation; means for estimating a PSF based on the focal point and the optical deformation; and means for generating a second image from the first image at least in part by enhancing the first region of the first image using the PSF. In some aspects, the optical deformation can occur in different regions and the method may include enhancing a second region of the first image using the PSF.

In some aspects, one or more of the methods, apparatuses, and computer-readable medium described above further comprise: determining a type of the optical deformation based on the PSF, wherein the type of deformation includes at least one of aberration associated with an optical setting, motion of the object, or a tilt. In some aspects, the first region and the second region are based on PSF of the tilt.

In some aspects, one or more of the methods, apparatuses, and computer-readable medium described above further comprise: enhancing the first region based on a determined motion of the object corresponding the PSF.

In some aspects, one or more of the methods, apparatuses, and computer-readable medium described above further comprise: enhancing the first region of the first image based on a PSF tilt and a tilt and a center point of the tilt; and enhancing a second region of the first image based on the tilt and the center point.

In some aspects, one or more of the methods, apparatuses, and computer-readable medium described above further comprise: enhancing the first region of the first image based on an optical setting used for capturing the first image, wherein the optical setting includes one of a type of lens or an aperture size of the lens.

In some aspects, the apparatus is, is part of, and/or includes a wearable device, an extended reality (XR) device (e.g., a virtual reality (VR) device, an augmented reality (AR) device, or a mixed reality (MR) device), a head-mounted device (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUS), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with some aspects;

FIG. 2 is a conceptual diagram illustrating a camera capturing an image of a scene in accordance with some aspects;

FIGS. 3A-3D illustrates a scene that is captured by a camera with a variable aperture lens using different focal ratios by controlling a size of the aperture, in accordance with some aspects;

FIG. 4 is a graph that illustrates depth of field (DOF) of different focal ratios based on focal distance from an optical system, in accordance with some aspects;

FIG. 5 illustrates a conceptual block diagram of an enhanced image capturing system that extends DOF in accordance with some aspects;

FIG. 6 illustrates a conceptual diagram of capturing an image with an enhanced image capturing system based on an extended DOF in accordance with some aspects;

FIGS. 7A-7D are images that illustrate different point spread functions (PSFs) in accordance with some aspects;

FIG. 8A illustrates an example of an image that has a defocused subject due to a DOF associated with a foreground subject, in accordance with some aspects;

FIGS. 8B-8E illustrate regions of an image with a defocused subjects and corrections based on extending a DOF, in accordance with some aspects;

FIG. 9 is a conceptual diagram illustrating a process to identify a minimum loss function and build a lookup table for an optical imaging system to extend DOF in some aspects

FIG. 10 is another conceptual diagram of a training system that trains an ML model to identify a loss function for an optical imaging system to extend DOF in accordance with some aspects;

FIG. 11 illustrates another conceptual illustration of a system for building a lookup table for identification of PSF associated with a plurality of defocused images and an ML model in accordance with some aspects;

FIG. 12 is a flowchart illustrating an example of a method for correcting images based on subjects located in different DOF regions

FIG. 13 is a flowchart illustrating an example of a method for correcting images for different types of distortion in accordance with some aspects;

FIG. 14 shows a block diagram of an example image processing device configured to capture images with subjects at different DOF, in accordance with some aspects; and

FIG. 15 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

A camera may include a variable aperture lens that controls an aperture size and an amount of light that is emitted into an image sensor. The aperture controls a focal ratio (sometimes referred to as an f-stop) that corresponds to a depth of field (DOF) associated with a focal point. Objects within the DOF will be focused and appear sharp, while objects that are not within the DOF will appear blurry. DOF is also associated with a distance of a focal point from the lens, where objects that are closer will be in focus and near objects can appear blurry based on the DOF.

In some aspects, systems, apparatuses, processes (also referred to as methods), and computer-readable media (collectively referred to herein as “systems and techniques”) are described for generating or capturing images using dynamic lens positions. In some aspects, the systems and techniques may capture images with subjects at different depths of fields at least in part by selecting a focal point between two subjects in the image, determining an optimized lens position based on the focal point, extracting defocused regions from an image captured using the optimized lens position, identifying a point spread function (PSF) corresponding to each extracted region, and processing the region using a region processing operation (e.g., using a deconvolutional operation, such as using a deconvolution filter or a frequency domain iterative algorithm with regularization) to enhance the extracted regions. The systems and techniques may then generate a final image by synthesizing the captured image with the enhanced regions.

In some aspects, the PSF and the processing of the region (e.g., using the deconvolutional operation) extend the DOF based on an optical defocusing factor. In some cases, the optical defocusing factor may be determined during calibration. The DOF of different subjects may partially overlap, and the focal point for the image can be selected based on the overlapping region. Based on the distance between a particular subject and a focal plane associated with the focal point, a PSF can be identified and the region processing (e.g., using the deconvolutional operation) can be applied to each region based on the PSF. In some aspects, the distance between the different subjects may be different and a different region processing operation (e.g., deconvolutional operation) may be applied to each defocused region. In some cases, a subject may be determined to be within a DOF and a different subject may be within an extended DOF based on the PSF. In such aspects, a subject may be positioned within a DOF and a region corresponding to a second subject may be corrected based on the PSF.

In some cases, a machine learning (ML) model (e.g., a deep neural network) can be configured to perform at least some of the aspects described herein, such as determining the PSF from an image based on a focal distance. In other aspects, the ML model (e.g., the deep neural network) can be configured to modify an extracted region of an image and implement various processes, such as the PSF estimation and deconvolution. An example of a deep neural network is a convolution neural network (CNN) with multiple hidden layers (e.g., with tunable or tuned weights and/or other parameters) between an input layer and an output layer.

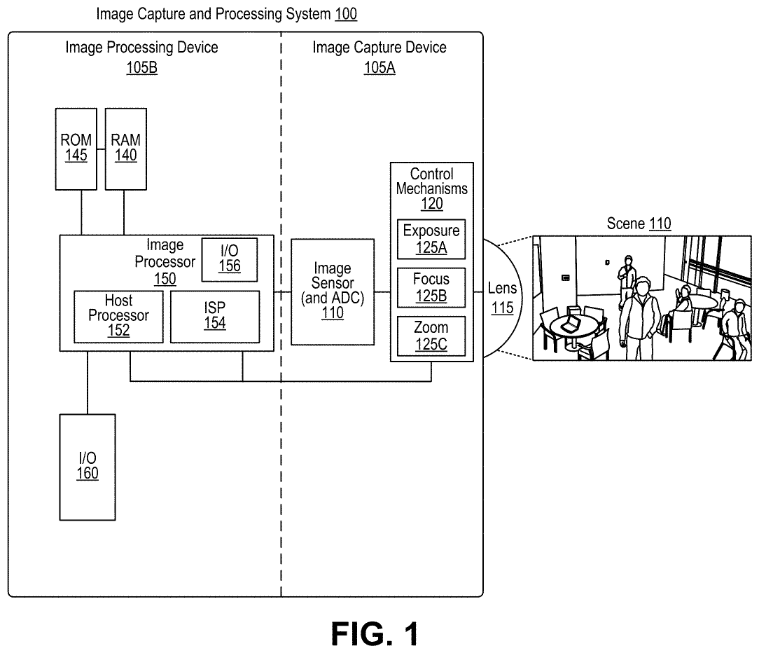

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B stores the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. The quad color filter array includes a 2×2 (or “quad”) pattern of color filters, including a 2×2 pattern of red (R) color filters, a pair of 2×2 patterns of green (G) color filters, and a 2×2 pattern of blue (B) color filters. The Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for PDAF. The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more ISPs (including ISP 154), one or more host processors (including host processor 152), and/or one or more of any other type of processor 1510 discussed with respect to the computing system 1500. The host processor 152 can be a digital signal processor (DSP) and/or other type of processor. The image processor 150 may store image frames and/or processed images in random access memory (RAM) 140/1520, read-only memory (ROM) 145/1525, a cache 1512, a memory unit 1515, another storage device 1530, or some combination thereof.

In some implementations, the image processor 150 is a single integrated circuit or chip (e.g., referred to as a system-on-chip (SoC)) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some. In certain situations, after an image is captured by the image sensor 130 (e.g., before the image is provided to and processed by the ISP 154), the image sensor 130 can perform a binning process to bin the quad color filter array pattern into a binned Bayer pattern. For instance, the quad color filter array pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high-quality image with higher brightness characteristics and less noise.

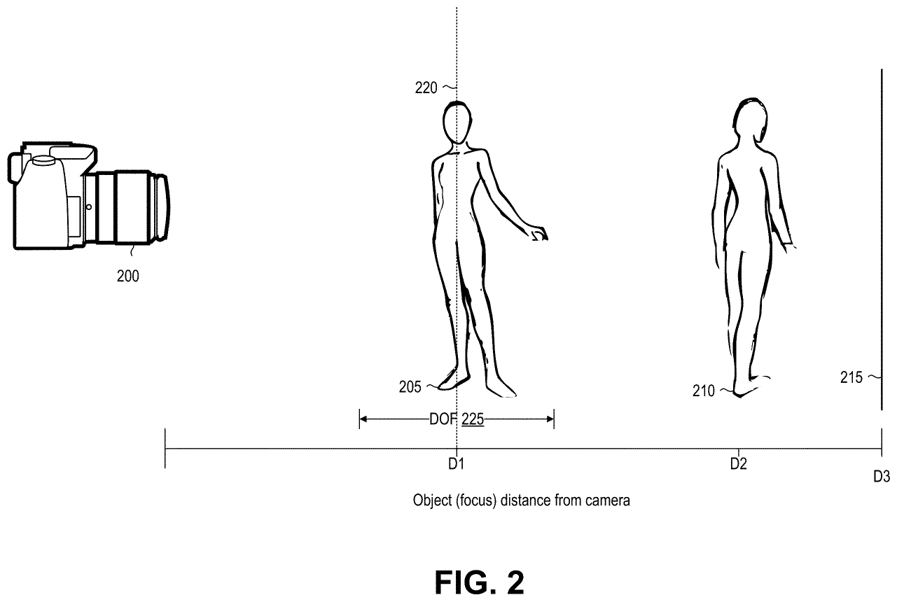

FIG. 2 is a conceptual diagram illustrating a camera capturing an image of a scene in accordance with some examples. In an image capturing system 200, the image capturing system can identify various objects in the scene. For example, the image capturing system 200 can identify multiple objects, such as an object 205 and another object 210. Although a person is illustrated as an example object, any type of animate or inanimate object can be identified, such as animals, vegetation, landmarks, vehicles, and so forth.

In many cases, the object 205 and the object 210 can be spaced apart by a distance. For example, the object 205 is located a distance D1 away from the image capturing system 200 and the object 210 is located a distance D2 away from the image capturing system. The image capturing system may also identify a background plane 215 at distance D3. When the image capturing system is instructed to capture an image, the image capturing system first determines a focal point 220 and adjusts a lens of the image capturing system 200 based on the focal point and various optical characteristics.

An illustrative optical characteristic is a focal ratio of a lens, which is commonly referred to as a f-number, f-ratio, or f-stop. The focal ratio is controlled by a variable aperture lens of the image capturing system 200. The variable aperture lens can include a diaphragm with moveable blades that control an aperture of the lens. The aperture permits light to enter into the lens and can reduce light exposure by decreasing size (e.g., radius) of the aperture, which in turn can affect the focal ratio. The focal ratio is generally denoted by “F/N,” where N is equal to the focal length of the lens divided by the aperture size. The aperture size may also be referred to as a pupil size. For example, a focal length of 40 mm and an aperture size of 10 mm yields a focal ratio of F/4.0. The focal ratio is a dimensionless number and is a quantitative measure of lens speed.

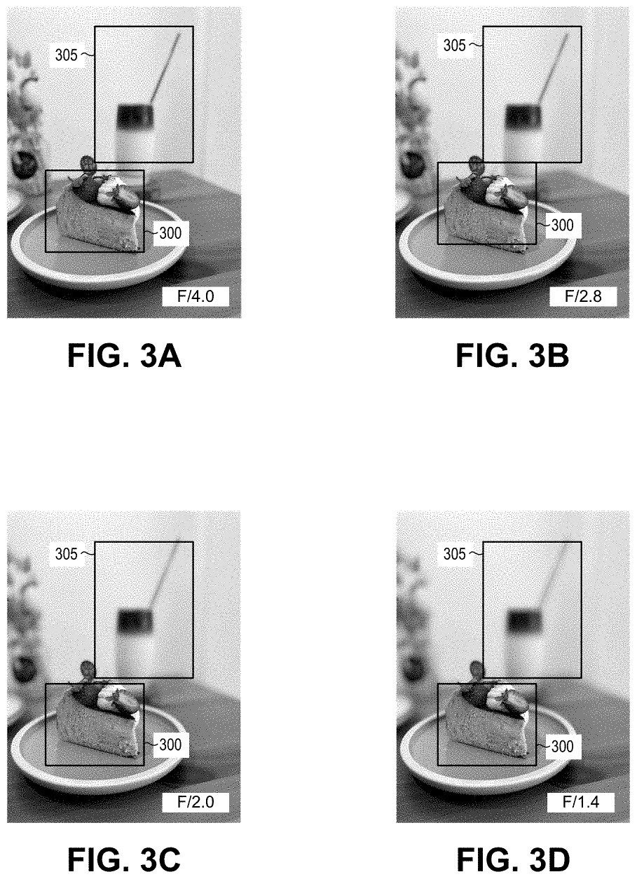

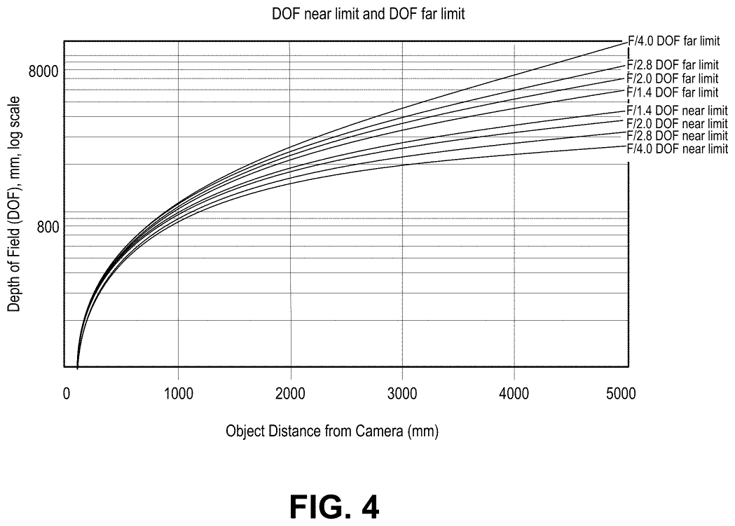

The focal ratio is related to a depth of field of a captured image. The depth of field is the range that objects are in focus from a focal point based on a distance to that focal point. A larger focal ratio has a larger depth of field and will have a larger range for objects to be in focus, and a smaller focal ratio has a smaller depth of field with a smaller range for objects to be in focus. Examples of a scene with different focal ratios and different depths of fields are illustrated in FIGS. 3A-3D, and a graph illustrating the depth of field of different focal ratios based on distance to the focal point is illustrated in FIG. 4.

When the image capturing system 200 is capturing the image, the image capturing system 200 may determine a focal ratio and then exposes an image sensor based on that focal ratio to generate an image. In some cases, the image capturing system 200 may control the focal ratio and display a snapshot or a preview images using a viewfinder. A user can perceive the viewfinder to operate the image capturing system 200 to focus on the correct subject of the image.

After the focal ratio and the focal point 220 are determined, the image capturing system 200 may capture an image based on a depth of field 225 that is centered at the focal point and can include objects in focus within that depth of field 225. For example, as illustrated in FIG. 4, the depth of field at a focal distance of 1 meter varies from is 1020 mm to 875 mm based on the focal ratio. For example, as illustrated in FIG. 2, the captured image may correctly have the first object 205 in focus, but the distance between the first user and the second user (D2−D1) may be outside of the depth of field 225 and the second object 210 will be blurry within that the captured image.

FIGS. 3A-3D are images of a scene that are captured by a camera with a variable aperture lens using different focal ratios by controlling a size of the aperture, in accordance with some aspects. The image of FIG. 3A illustrates a scene captured with a focal ratio of F/4.0. The image of FIG. 3B illustrates the same scene illustrated in FIG. 3A, but captured with a focal ratio of F/2.8. The image of FIG. 3C illustrates the same scene illustrated in FIG. 3A captured with a focal ratio of F/2.0. The image of FIG. 3D illustrates the same scene illustrated in FIG. 3A captured with a focal ratio of F/1.4.

As noted above, the depth of field is related to the focal ratio or f-stop. FIGS. 3A, 3B, 3C, and 3D each include a foreground content 300 that corresponds to a focal point of the lens and a background content 305 that becomes blurrier as the focal ratio and the depth of field also decreases. In particular, the background content 305 illustrated in FIGS. 3A, 3B, 3C, and 3D is a beverage with a straw and the visual fidelity of the straw decreases as the focal ratio decreases. However, the foreground content 300 is similar in each captured image illustrated in FIGS. 3A, 3B, 3C, and 3D and does not perceivably vary to a naked human eye.

FIG. 4 is a graph that illustrates depth of field (DOF) of different focal ratios based on focal distance from an optical system, in accordance with some aspects. In particular, FIG. 4 illustrates a near limit and a far limit of each focal ratio, which corresponds to the depth of field. As illustrated in FIG. 4, the depth of field at a focal distance of 1 meter varies from is 1020 mm to 875 mm for different focal ratios. At a focal distance of 4 meters, the depth of field varies from 8000 mm to 1175 mm.

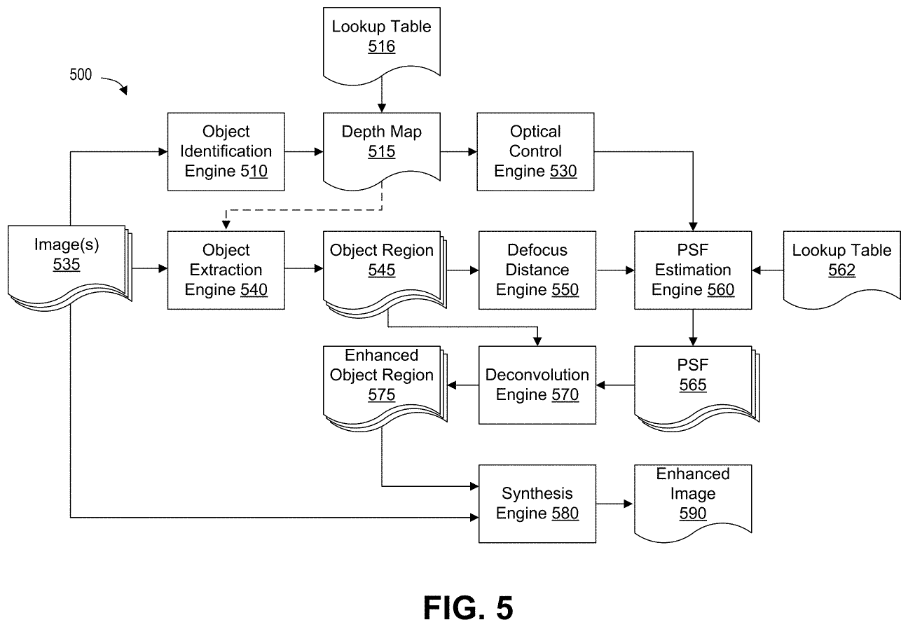

FIG. 5 illustrates a conceptual block diagram of an enhanced image capturing system 500 that can capture images using dynamic lens positions, in accordance with some aspects. The image capturing system 500 may effectively extend the DOF of the image capturing system 500 (e.g., a camera with a smaller aperture). As shown in FIG. 5, the image capturing system 500 includes an object identification engine 510, an optical control engine 530, an object extraction engine 540, a defocus distance engine 550, a point spread function (PSF) estimation engine 560, a deconvolution engine 570, and a synthesis engine 580. In some examples, the image capturing system 500 may be configured to use computer-vision techniques and/or machine learning (ML) to enhance or deblur images that are blurred.

In some aspects, the image capturing system 500 processes one or more images 535. For example, the one or more images 535 may include an image that was previously captured (e.g., a preview or snapshot image), which is referred to as a first image. The first image may be obtained or retrieved (e.g., from a camera, from storage, from another device, etc.) by the object identification engine 510. In some examples, the first image may be displayed (e.g., as a preview image) in a display or viewfinder of the image capturing system 500. The object identification engine 510 may detect if there are two objects in the first image, such as by performing object detection. The object detection may be performed using computer-vision and/or machine learning (e.g., using a convolutional neural network (CNN) configured to detect one or more objects in an image) based techniques. The object identification engine 510 may detect two different objects in the scene that are located at different positions between the camera and the background plane.

The image capturing system may obtain (e.g., from another device), retrieve (e.g., from storage), or generate a depth map 515 for the first image. The depth map 515 may be a two-dimensional array of pixels with the value of each respective pixel in the depth map 515 identifying a distance of the respective pixel from the image capturing system 500 (e.g., a camera of the image capturing system 500) to an object in the scene for which that pixel belongs. In some aspects, when the object identification engine 510 identifies objects within a single range (e.g., a DOF of a particular focal ratio), the image capturing system 500 may capture the image using conventional methods.

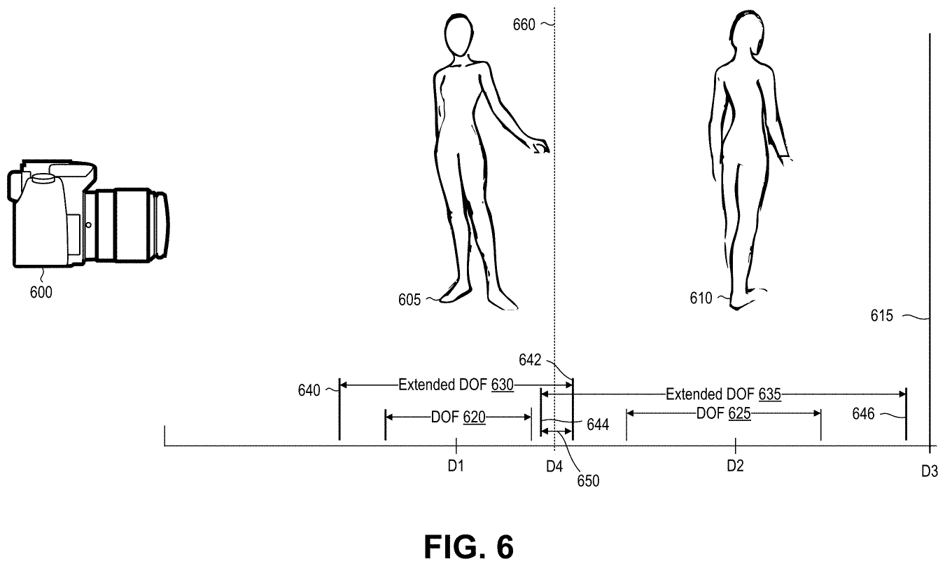

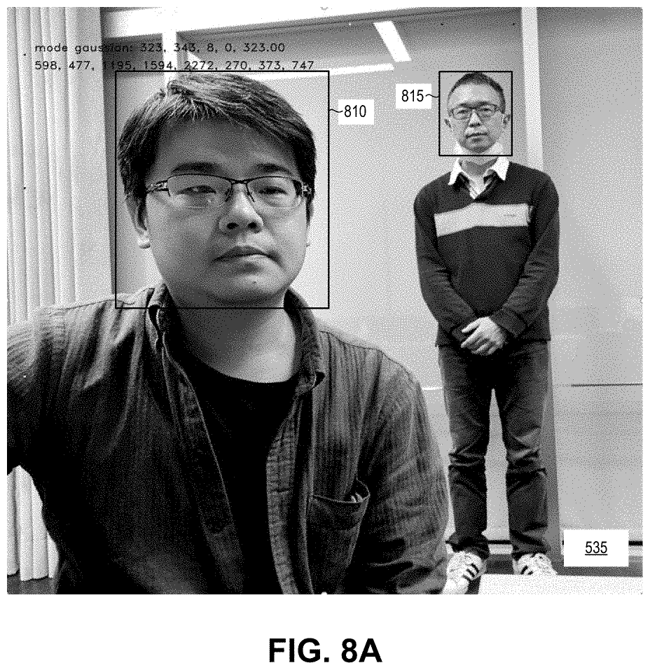

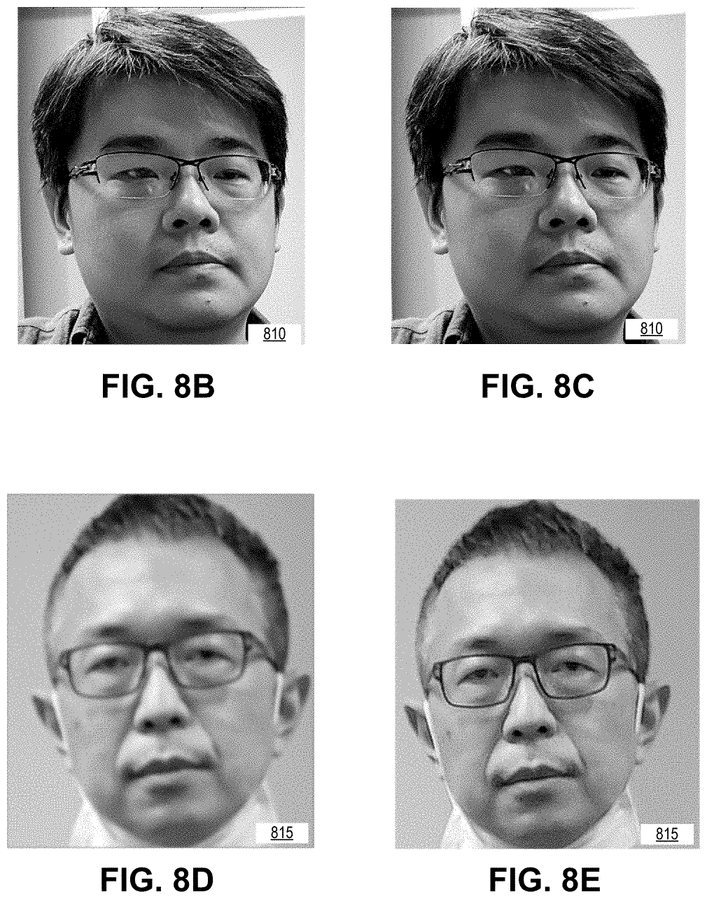

In some cases, the depth map 515 can be provided to the optical control engine 530 for determining various optical characteristics to use for capturing a subsequent image. For example, the optical control engine 530 can determine a focal ratio, an exposure time, and so forth. In some aspects, when the depth map 515 includes objects that are at different focal distances, the optical control engine 530 can determine a distance of each object from the depth map 515. The optical control engine 530 can obtain a lookup table 516 that maps distances with different DOFs. Using the lookup table 516 and each respective distance determined for each object from the depth map 515, the optical control engine 530 can determine a respective DOF for each object. The optical control engine 530 can then determine a focal point between the objects based on the determined DOFs. An example of determining a focal point between objects is further illustrated with reference to FIG. 6. The optical control engine 530 can use the determined focal point between the objects to determine an optimal lens position for capturing an image. For example, in response to determining the optical characteristics, the image capturing system 500 can control the various devices (e.g., lens, image sensor, etc.) to capture a second image (from the one or more images 535) at the optimal lens position and based on the determined characteristics (e.g., focal ratio, focal distance, exposure time, etc.). An example of the second image is illustrated with reference to FIG. 8A.

The second image may be provided to the object extraction engine 540 to extract at least one region from the second image. Examples of regions extracted from the image illustrated in FIG. 8A are illustrated in FIG. 8B and FIG. 8D. In some aspects, the second image may be provided to the object identification engine 510 to generate a depth map corresponding to the second image, or the depth map 515 from the first image can be used to identify the regions in the second image that correspond to the objects. For purposes of illustration, the image capturing system 500 is illustrated to receive the depth map 515 for the objection extraction engine 540 to extract at least one object region 545 from the second image. In some aspects, the image capturing system 500 generates a region for each subject in a different DOF region, as shown in FIG. 6.

The object region 545 is provided to the defocus distance engine 550 to determine a respective defocus distance between each region (associated with each object) and the focal point determined by the optical control engine 530. As noted above, the focal point is associated with the optimized lens position. For example, the defocus distance engine 550 can determine a first defocus distance between a first region (corresponding to a first object in the second image) and the focal point determined by the optical control engine 530 and can determine a second defocus distance between a second region (corresponding to a second object in the second image) and the focal point.

The defocus distance engine 550 may output the determined defocus distances to the PSF estimation engine 560. In some aspects, the PSF estimation engine 560 may also receive optical information related to the second image, such as focal distance, focal ratio, and so forth. Based on the defocus distances of each object region 545 and in some cases the optical information of the second image, the PSF estimation engine 560 is configured to determine a PSF 565 for each object region 545. In some cases, the defocus distance engine 550 can be omitted and the PSF estimation engine 560 can select a PSF based on a quantification of the blur in the second image. The quantification of the blur can be based on a sharpness value, such as a distance between an intensity difference (e.g., between 10% of a minimum intensity and 90% of a maximum intensity), or can be based on a modulation transfer function (MTF).

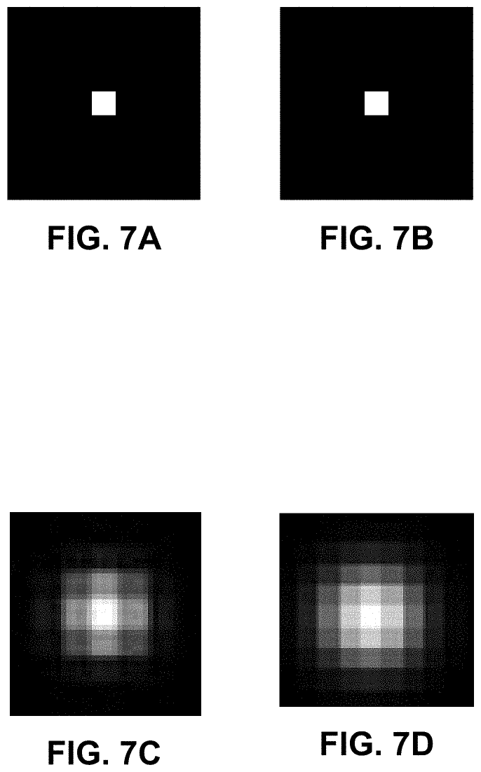

In some aspects, the PSF specifies a response of an imaging system to a point source or point object. The PSF can be considered an optical transfer function associated with an optical imaging system, or an impulse function such as a single frequency in the frequency domain. The PSF identifies the spatial domain transformation of a single pixel. For example, an input of a single pixel into an optical system would be a blurring pixel based on an incorrect focus. Examples of PSF transform functions are illustrated in FIGS. 7A, 7B, and 7C herein.

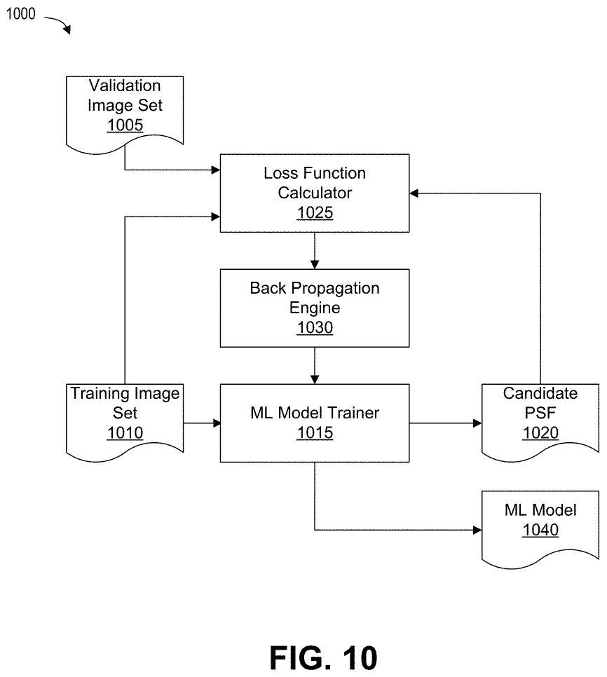

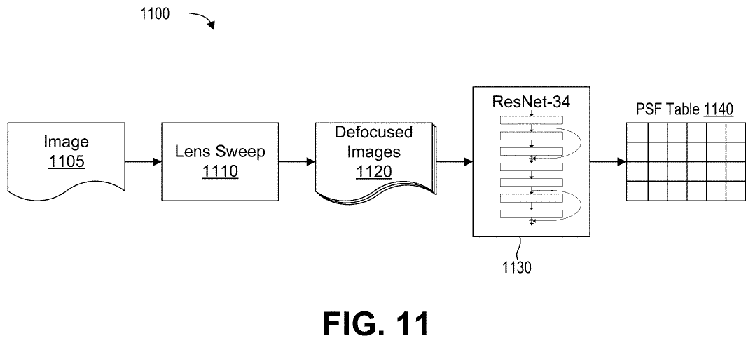

The PSF estimation engine 560 can be implemented by various mechanisms. In some aspects, the PSF estimation engine 560 can be performed using a lookup table 562. In some cases, one axis or dimension of the lookup table 562 can include the defocus distance associated with a region and the other axis or dimension may be the corresponding PSF value. The PSF estimation engine 560 may receive the defocus distance values from the defocus distance engine 550 and look up a corresponding PSF 565 for each region 545 from the lookup table 562 based on each respective defocus distance. The lookup table 562 can be generated different mechanisms such as an iterative process or by training a machine learning model. Illustrative examples of mechanisms to build the lookup table 562 for the PSF estimation engine 560 are illustrated in FIG. 10 and FIG. 11. In some cases, the PSF estimation engine 560 may be able to execute an algorithm to determine the PSF, such as by a distributed computer system or a single computer system that does not require a low latency.

In some aspects, each object region 545 extracted by object extraction engine 540 and each PSF 565 for each object region 545 are provided to a deconvolution engine 570. The deconvolution engine 570 uses the PSF 565 for each corresponding object region 545 and performs an inverse of the PSF 565 to generate an enhanced object region 575 from each object region 545. In one illustrative example, the deconvolution engine 570 applies a deconvolutional operation (e.g., using a deconvolution filter or a frequency domain iterative algorithm with regularization that iteratively updates parameters until optimal parameters are identified) to each object region 545. Using the deconvolutional operation, the deconvolution engine 570 corrects the optical characteristics that are caused by changing the focal distance to a point between the objects. Examples of enhanced object regions 575 are illustrated and described herein with reference to FIG. 8C and FIG. 8E.

A synthesis engine 580 receives each of the enhanced object regions 575 and the second image and synthesizes and outputs an enhanced image 590 that corrects issues such as blurring, noise, and so forth based on the focal distance. In some cases, each enhanced image 590 may contain metadata that identifies an exact pixel location of the region within the second image that corresponds to the object region 545 and can perform different methods to synthesize the resulting enhanced image 590. For example, the synthesis engine 580 may combine pixels of the second image with the pixels of the enhanced object region based on a saturation value to remove pixels that would decrease a sharpness value. Other types of synthesis may be implemented such as a linear interpolation, an average, and so forth.

FIG. 6 illustrates a conceptual diagram of capturing an image with an enhanced image capturing system 600 based on an extended DOF in accordance with some examples. In the illustrative example of FIG. 6, the scene includes a first object 605 located a distance D1 from the image capturing system 600 and a second object 610 located a distance D2 from the image capturing system 600. A background plane 615 is located at a distance D2 from the image capturing system.

The image capturing system 600 may be configured to identify the first object 605 and the second object 610 are physically located in different DOF regions. For example, the first object 605 is located in a DOF 620 associated with a particular focal ratio, and the second object 610 is located in a DOF 625. In this illustrative example, the DOF 620 and the DOF 625 are distinct ranges and do not overlap. When the image capturing system 600 identifies this scenario, the image capturing system 600 may be configured to determine an extended DOF 630 that extends a distance of the DOF 620, and an extended DOF 635 that extends the range of the DOF 625. For example, the extended DOF 630 has a near limit 640 and a far limit 642 based on improvements provided by the deconvolution. The extended DOF 635 also has a near limit 644 that is before the far limit of the extended DOF 630, and a far limit 646. The extended DOF 630 and extended DOF 635 may have different applicable ranges because, as illustrated in FIG. 4, DOF is a function of focal ratio and focal distance.

In some aspects, the image capturing system 600 can correct blur associated with defocused images outside of the DOF region by identifying a PSF of the defocused image and a focal distance of the image. As described above, the PSF is a transfer function and a deconvolutional operation performed based on the PSF can improve the quality of defocused regions of an image. In the illustrative example of FIG. 6, the image capturing system 600 can identify an overlapping region 650, which is a position between the far limit 642 of the extended DOF 630 and a near limit of the extended DOF 635. Based on the overlapping region, the image capturing system 600 can select a focal point 660 at location D4. In this illustrative example, both the first object 605 and the second object 610 are within a depth of field that can be corrected.

After selecting the focal point 660, in which both the first object 605 and the second object 610 are not within an optical DOF, both the first object 605 and the second object 610 are defocused in the image provided from the image sensor. The image capturing system 600 can determine a defocus distance between the first object 605 and the focal point 660 and a defocus distance between the second object 610 and the focal point 660. Using the defocus distances, image capturing system 600 can determine the PSF for each of the objects 605 and 610, as described above in FIG. 5, and apply a deconvolution to enhance the image. Different variations are possible, such as maintaining one object within focus when the DOF of an object can be extended to include the second object 610, for example. In other aspects, the PSF estimation and deconvolution can be used to correct other types of distortions, such as aberrations associated with a large lens with a low focal ratio, tilt associated with the lens, or motion within an image.

FIGS. 7A-7D are images that illustrate different PSFs in accordance with some examples. FIG. 7A illustrates a bitmap that is input into an optical system to measure a PSF of that optical system. FIG. 7B illustrates an output of that optical system when the optical system has no response and does not distort the input bitmap illustrated in FIG. 7A. FIG. 7C illustrates an output of that optical system when the optical system is slightly defocused and lightly blurs the input bitmap illustrated in FIG. 7A. FIG. 7D illustrates an output of that optical system when the optical system heavily defocused and significantly blurs the input bitmap illustrated in FIG. 7A.

As illustrated in FIGS. 7C, and 7D, the PSF is a loss function that visually depicts how pixels are spread by a transfer function. For a known PSF, that loss can be inverted, for example, by building a matrix transformation. In some aspects, the PSF can be determined based on an iterative algorithm or using an ML model with defocused images and focused images to train the ML model.

FIG. 8A illustrates an example of an image that has a defocused subject due to a DOF associated with a foreground subject, in accordance with some examples. In some aspects, the image illustrated in FIG. 8A may correspond to the second image (from the images 535 described with respect to FIG. 5) that is captured based on a focal point that is between a first object 810 and a second object 815.

FIG. 8B is an image that illustrates a region extracted from the image that corresponds to the first object 810. Although difficult to perceive, the shadows and highlights of the first object 810 may be slightly blurry and have less sharpness. FIG. 8C illustrates the deconvolution result of the image of FIG. 8B based on the PSF. The image in FIG. 8C has slightly increased sharpness of various features of the first object as compared to the image in FIG. 8B. In particular, shadows and highlights are improved and edges of glasses are more distinct as compared to the image in FIG. 8A.

FIG. 8D is an image that illustrates another region extracted from the image that corresponds to the second object 815. In particular, this image illustrates that the second object 815 is more defocused based on the focal point selected by the image capturing system and features of the face, such as ears, are blurrier. FIG. 8E illustrates the deconvolution result of the image of FIG. 8D based on the PSF. The image in FIG. 8E has significantly increased sharpness of various features of the second object 815 as compared to the image in FIG. 8D. In particular, features of the face are significantly clearer and the face is more distinct as compared to the image in FIG. 8D.

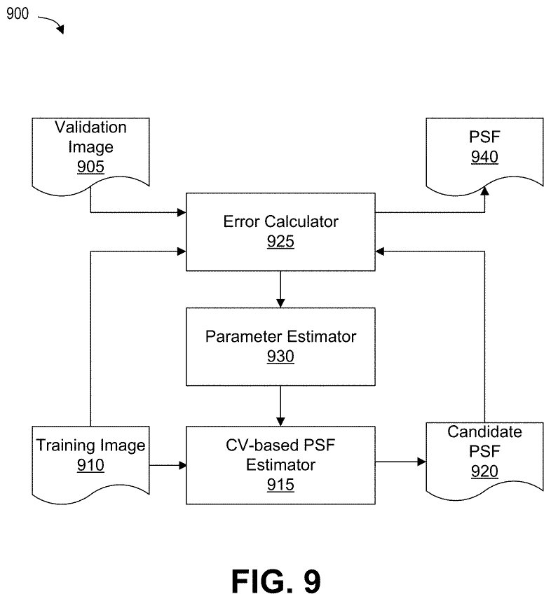

FIG. 9 is a conceptual diagram illustrating a system 900 that is configured to identify a minimum loss function and build a lookup table (e.g., lookup table 562 of FIG. 5 for identifying appropriate PSFs) for an optical imaging system to extend DOF in some aspects. In particular, the system 900 performs an iterative process using a computer vision (CV)-based PSF estimation algorithm until a minimum loss function is identified. This iterative process performed by the system 900 is performed based on a focal distance and a blurring applied to training images.

In particular, the system 900 includes a validation image 905 and a training image 910. The training image 910 is provided to a CV-based estimator 915 to generate a candidate PSF 920 associated with the training image 910. In some aspects, the CV-based estimator 915 uses an initial set of parameters to generate the candidate PSF 920. The candidate PSF 920 is provided to an error calculator 925 to compare the candidate PSF 920 to the validation image. In some aspects, the error calculator 925 may perform a deconvolution of the training image 910 based on the candidate PSF 920 and perform an image comparison with the validation image 905 to determine an accuracy.

The error calculator 925 quantifies an error using various metrics and provides the errors to a parameter estimator 930, which determines parameters for the CV-based estimator 915 using various types of algorithms, such as a gradient descent. After computing the revised set of parameters, the revised set of parameters are provided to the CV-based estimator 915 to repeat determining the candidate PSF 920 and error calculation. This process continues until the error calculator 925 determines that the candidate PSF 920 corresponds to a maximum error correction of the training image 910, and a PSF 940 is output.

In some aspects, the validation image is associated with a focal distance and the training image is defocused or distorted based on a transfer function, and the PSF 940 corresponds to a single data point of a multiple axis table for correcting images. This process would occur for each data point of the lookup table. For example, this process would occur for each focal point of an imaging system with training images 910 that are at various defocus distances.

FIG. 10 is another conceptual diagram of a training system that trains an ML model to identify a loss function for an optical imaging system to extend DOF in some aspects. In some aspects, the various object regions (e.g., object regions 545) can be applied to the ML model and the ML model can identify a PSF and perform the deconvolution based on the PSF. The ML model can be provided parameters such as focal depth, distances to the corresponding object regions from the focal depth, and various camera setting such as focal ratio. Because the resulting ML model is a linear or a non-linear transformation based on a number of layers, the ML model can be implemented in a mobile device to perform the logic and math associated with the ML model with minimal latency and power consumption.

The training system 1000 includes a validation image set 1005 and a training image set 1010 that are used to create an ML model 1040. The training images from the training image set 1010 are provided into an ML model trainer 1015 that configures receives the ML model and applies the training images to build candidate PSFs 1020. The candidate PSFs 1020 are returned to a loss function calculator 1025 that determines a loss based on a comparison of a training image with a corresponding validate images from the validation image set 1005.

The loss calculated by the loss function calculator 1025 is provided to a back propagation engine 1030 that propagates the errors back to the previous layers of the ML model to update the ML model. The ML model is then provided to the ML model trainer 1015 and the process continues until a minima function of the ML model trainer 1015 determines that a minimum loss is identified based on the parameters of the ML model and the ML model 1040 is output.

The training system 1000 is conceptual illustrations and implementation may include additional steps and processes. For example, the training system 1000 illustrates comparison to a validation image set during training, and the ML model 1040 can be applied to additional validation processes without a known validation input. In another aspects, an initial loss function may be applied to the back propagation engine 1030 to reduce training time.

FIG. 11 illustrates another conceptual illustration of a system 1100 for building a lookup table (e.g., lookup table 562 of FIG. 5) for identification of PSF associated with a plurality of defocused images and an ML model. The system 1100 may be configured to build a lookup table, such as a PSF table 1140, during calibration of an image capturing system. In some aspects, the system 1100 may be performed at design time and various factors can be determined during calibration.

In some illustrative aspects, an image may be input into the system 1100 and a lens sweep 1110 is performed to generate a plurality of defocused images 1120 for each iteration of the lens sweep. In some aspects, an image 1105 is received by the system 1100 and the system 1100 performs a lens sweep 1110 to generate the defocused images 1120 based on each iteration of the sweep. The defocused images and individually provided into an ML model 1130. The ML model 1130 may include any suitable ML system that can be used to generate the PSF for deconvolution to enhance the defocused images. In one illustrative example, the ML model 1130 may be a residual neural network (ResNet) ML model with 34 layers (ResNet-34), a convolution neural network (CNN), a deep neural network (DNN), any other type of deep neural network (e.g., trained using supervised, unsupervised, or semi-supervised learning/training), any combination thereof, and/or ML model or system. In some aspects, the ML model 1130 may be configured to identify a loss function such as a PSF or other parameters that can be converted into a PSF.

For each defocused image of the defocused images 1120, the ML model 1130 can populate one or more data sources for the image capturing system. For example, the ML model 1130 can build a PSF table 1140 having an axis or dimension corresponding to a defocus distance and another axis or dimension corresponding to the corresponding PSF. As described in detail above, the PSF table 1140 can be used to identify the PSF (e.g., PSF 565) and a deconvolution function (e.g., deconvolution engine 570) can use the PSF to enhance a distorted bitmap. For example, the PSF can be used to enhance sharpness of a region in a single image that is defocused because that object is not within a DOF that is limited based on optical characteristics.

In some other aspects, the ML model 1130 can be configured to enhance an input image based on input parameters. For example, the ML model 1130 can receive an extracted portion of a bitmap image, optical characteristics (e.g., focal distance, focal ratio, etc.), and a focal difference between a location of the extracted portion of the bitmap image and the focal distance. For example, an object may be 10 meters behind a focal point and the object may be outside of the DOF of the lens. Based on the input, the ML model 1130 may be configured to enhance the extracted portion of the bitmap image based on, for example, a deconvolution that the ML model 1130 is trained to perform.

Although FIG. 11 illustrates using a ResNet model, the output ML model 1130 may be trained using any suitable ML model, or the ML model can be included to add further information into the enhanced regions. In one illustrative aspect, the ML model 1130 may be an adversarial network such as a generational adversarial network (GAN) that uses an adverse ML model. For example, the GAN includes a generative model that creates data and an adversarial network that classifies the data as fake (e.g., from the generative model) or real and trains the generative model to add content to an image. For example, the generative model can be implemented to create detail to improve the quality of an image to extend the DOF.

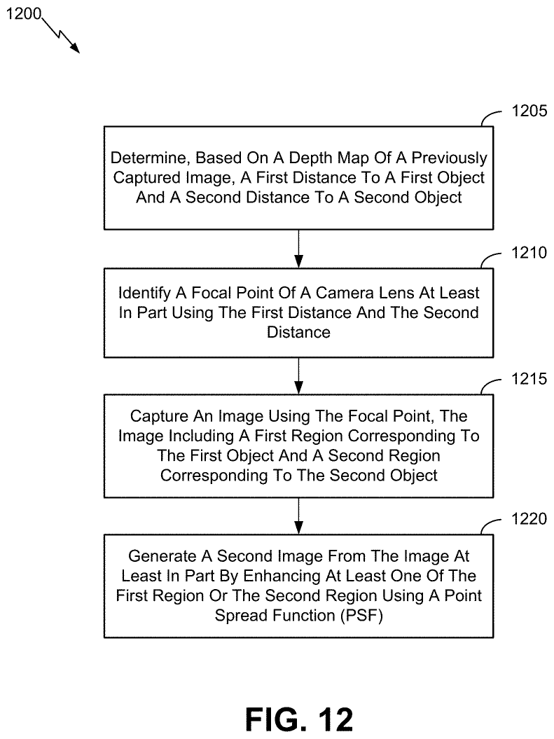

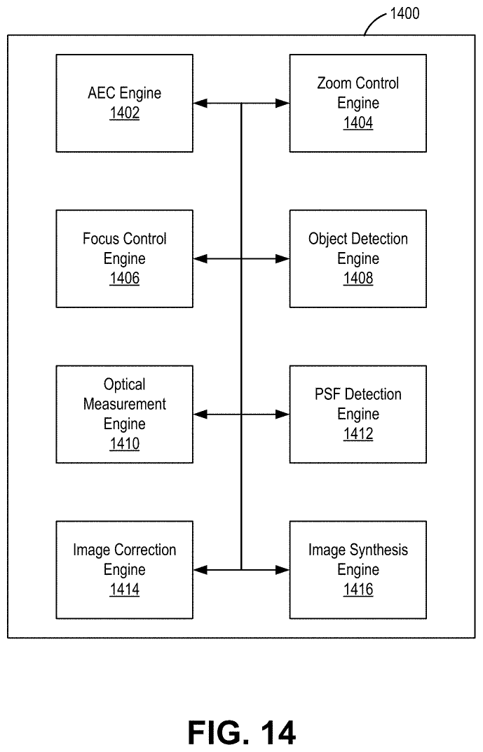

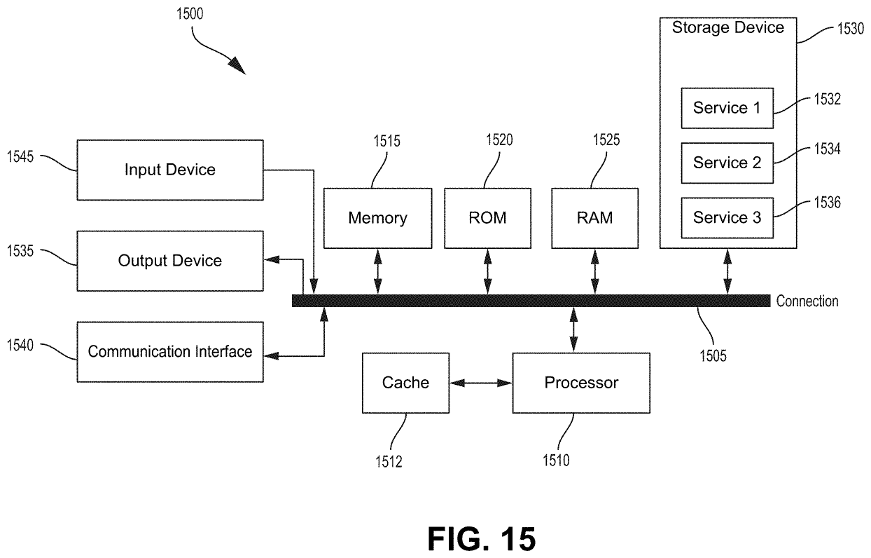

FIG. 12 is a flowchart illustrating an example of a method 1200 for correcting images based on subjects located in different DOF regions. The method 1200 can be performed by a computing device having one or more image sensors (e.g., cameras), such as a mobile wireless communication device, a camera, an extended reality (XR) device (e.g., a virtual reality (VR) device, an augmented reality (AR) device, or a mixed reality (MR) device), a wireless-enabled vehicle, or other computing device. In some cases, the computing device can include an image processing device (e.g., the image processing device 1400 of FIG. 14). In some cases, the computing device can include or can be the computing system 1500 of FIG. 15.

According to some aspects, at block 1205, the computing device may determine, based on a depth map of a previously captured image, a first distance to a first object and a second distance to a second object. In some aspects, the first object is a face of a first person and the second object of a face of a second person. In some other aspects, the objects can be animate objects, landmarks, people, and so forth.

At block 1210, the computing device may identify a focal point of a camera lens at least in part using the first distance and the second distance at block 1220. In one illustrative aspect, the computing device can determine a first depth of field associated with the first object and a second depth of field associated with the second object and identify the focal point as a point between the first depth of field and the second depth of field. The first depth of field is determined using a lookup table based on a depth associated with the first object, and the second depth of field is determined using the lookup table based on a depth associated with the second object.

At block 1215 (e.g., after determining the focal point), the computing device may capture an image using the focal point as a basis for the capture. The captured image includes a first region that corresponds to the first object and a second region that corresponds to the second object.

In one illustrative aspect, the computing device select a PSF based on at least one of a distance between the first object and the focal point and distance between the second object and the focal point. In some aspects, the PSF is selected from a lookup table. One illustrative lookup table includes a defocus distance (e.g., a distance between an object and a focal point) and a blur quantity. The lookup table may be determined using a deep learning model or an ML model trained using defocused images and a loss function to correct the defocused images. In some other aspects, the lookup table is determined using a computer vision-based PSF estimate determined from defocused images and an error calculation and iteratively modifying the computer vision-based PSF estimate until a minimum error is identified for each focal distance and each amount of blur.

At block 1220, the computing device may generate a second image from the image at least in part by enhancing at least one of the first region or the second region using a PSF. To enhance the at least one of the first region or the second region based on the PSF, the computing device may generate a modified first region at least in part by applying a deconvolution operation to the first region based on the PSF. In some aspects, the computing device may generate a modified second region at least in part by applying a deconvolution operation to the second region based on the PSF.

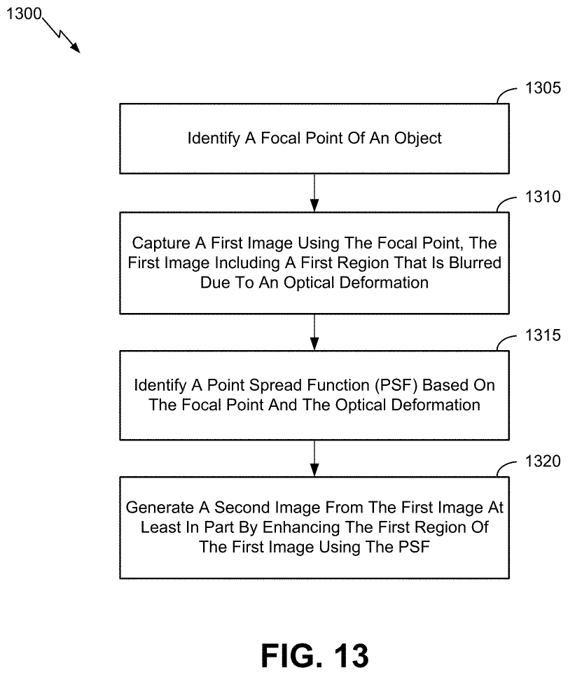

FIG. 13 is a flowchart illustrating an example of a method 1200 for correcting images for different types of distortion. The method 1300 can be performed by a computing device having one or more image sensors (e.g., cameras), such as a mobile wireless communication device, a camera, an extended reality (XR) device (e.g., a virtual reality (VR) device, an augmented reality (AR) device, or a mixed reality (MR) device), a wireless-enabled vehicle, or other computing device. In some cases, the computing device can include an image processing device (e.g., the image processing device 1400 of FIG. 14). In some cases, the computing device can include or can be the computing system 1500 of FIG. 15.

According to some examples, the computing device may identify a focal point of an object at block 1305. At block 1310 (e.g., after identification of the focal point), the computing device may capture a first image using the focal point as a basis for the capture.

Using the captured image, the computing device may determine a type of the optical deformation, such as a blur, based on the PSF that degrades the image. Examples of optical deformations incudes blur, motion of an object (motion blur), tilt associated with capturing the image, an aberration due to camera characteristics. Other types of optical deformations and other types of blur are possible.

At block 1315 (e.g., after the image is captured), the computing device may estimate a PSF based on the focal point and the optical deformation (e.g., the blur). In some aspects, the PSF may be based on different regions, the PSF may be associated with an object that is moving while the image was captured.

At block 1320, the computing device may generate a second image from the first image at least in part by enhancing the first region of the first image using the PSF. If the distortion corresponds to motion, the computing device may use the determined motion of the object corresponding the PSF to remove the distortion. If the distortion corresponds to tilt, the computing device may enhance the first region of the first image based on a tilt and a center point of the tilt, and enhance a second region of the first image based on the tilt and the center point. The tilt may be differ based on angular rotation and different points and the computing device may divide the image into different regions and enhance region differently. If the distortion corresponds to tilt, the computing device may enhance the first region of the first image based on an optical setting used for capturing the first image. For example, the optical setting includes one of a type of lens or an aperture size of the lens.

In some examples, the processes described herein (e.g., methods 1200 and 1300, and/or other process described herein) may be performed by a computing device or apparatus. In one example, the methods 1200 and 1300 can be performed by a computing device (e.g., image capture and processing system 100 in FIG. 1) having a computing architecture of the computing system 1500 shown in FIG. 15.

The computing device can include any suitable device, such as a mobile device (e.g., a mobile phone), a desktop computing device, a tablet computing device, a wearable device (e.g., a virtual reality (VR) headset, an augmented reality (AR) headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the method 1200 and method 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The methods 1200 and 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The methods 1200 and 1300, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 shows a block diagram of an example image processing device 1400 configured to capture images with subjects at different DOFs according to some aspects. In some aspects, the image processing device 1400 is configured to perform one or more of the methods or processes described above. The methods can include the methods 1200 and 1300, as well as any other process described herein.

The image processing device 1400 may be an example aspect of the image processing device 105B described above with reference to FIG. 1. For example, ISP 1400 can be a chip, system-on-chip (SoC), chipset, package or device that includes a hardware processor, hardware circuitry, programmable circuitry, and/or software engines or modules to perform various functions. The image processing device 1400 may include an autoexposure control (AEC) engine 1402, a zoom control engine 1404, a focus control engine 1406, an object detection engine 1408, an optical measurement engine 1410, a PSF detection engine 1412, an image correction engine 1414, and an image synthesis engine 1416.

The AEC engine 1402 may be configured to control exposure settings of the lens, such as a focal ratio and an exposure time. The AEC engine 1402 may also control a gain setting that is applied to an image. In some aspects, the AEC engine 1402 may control a diaphragm to control the aperture size by causing blades of the diaphragm to move. The AEC engine 1402 can include functions to determine when the diaphragm is finished moving. The AEC engine 1402 can also receive information, such as depth of field, related to a scene and control operation of the lens to capture images based on the depth of field to ensure that the subject and the background content are within focal range. In some cases, the AEC engine 1402 can determine a focal ratio (and corresponding aperture size), an exposure time, and a gain of different images that will be merged into a single HDR image.

The zoom control engine 1404 is configured to perform any optical zoom or digital zoom function. The zoom control engine 1404 may also receive information related to a subject of an image provide information related to the subject, as well as any zoom information, to the focus control engine 1406. The zoom control engine 1404 is configured to perform electrical or mechanical operations to focus the lens and other processing to change the focal length to correspond to a distance from the image processing device 1400 to a subject identified by the image processing device 1400.

An object detection engine 1408 may be configured to identify at least one object in a snapshot image. For example, the object detection engine 1408 may generate a depth map to determine a distance to objects in the snapshot image. In some aspects, the object detection engine 1408 may identify that multiple objects are in the snapshot image and may be within different DOF based on a lens setting. In such cases, the object detection engine 1408 may provide the information to the focus control engine 1406, which can determine the focal point based on various parameters. For example, the focus control engine 1406 can use an extended DOF to identify a focal point. Based on the identified focal point, the image capturing system captures a single image and can extract portion of that image for enhancement.

In some aspects, at least some of the engines 1402, 1404, 1406, 1408, 1410, 1412, 1414, and 1416 are implemented at least in part as software stored in a memory. For example, portions of one or more of the engines 1402, 1404, 1406, 1408, 1410, 1412, 1414, and 1416 can be implemented as non-transitory instructions (or “code”) executable by at least one processor to perform the functions or operations of the respective engine. In some cases, at least some of the engines 1402, 1404, 1406, 1408, 1410, 1412, 1414, and 1416 may be implemented by a circuit, such as an application specific integrated circuit (ASIC) or programmable circuit such as a functional programmable gate array (FPGA).

FIG. 15 is a diagram illustrating an example of a system for implementing certain aspects of the present technology. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1500 includes at least one processing unit (CPU or processor) 1510 and connection 1505 that couples various system components including memory unit 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, wireless local area network (WLAN) signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the disclosure include:

Aspect 1: A method for capturing an image, comprising: determining, based on a depth map of a previously captured image, a first distance to a first object and a second distance to a second object; identifying a focal point of a camera lens at least in part using the first distance and the second distance; capturing an image using the focal point as a basis for the capture, the image including a first region corresponding to the first object and a second region corresponding to the second object; and generating a second image from the image at least in part by enhancing at least one of the first region or the second region using a PSF.

Aspect 2: The method of Aspect 1, further comprising: selecting the PSF based on at least one of a distance between the first object and the focal point and distance between the second object and the focal point. In some aspects, if the focus point is on first object, a second object may be blurred. A PSF is selected to deblur a second region. In some other aspects, if focus point is between first and second objects, the first and second objects may be blurry and two PSFs may are selected to enhance first region and the second region.

Aspect 3: The method of any of Aspects 1 or 2, wherein the PSF is selected from a lookup table.

Aspect 4: The method of Aspect 3, wherein the lookup table is determined using a ML model trained using defocused images and a loss function to correct the defocused images.

Aspect 5: The method of any of Aspects 3 or 4, wherein the lookup table is determined using a computer vision-based PSF estimate determined from defocused images and an error calculation and iteratively modifying the computer vision-based PSF estimate until a minimum error is identified for each focal distance and each amount of blur.

Aspect 6: The method of any of Aspects 1 to 5, wherein enhancing at least one of the first region or the second region based on the PSF comprises: generating a modified first region at least in part by applying a deconvolution operation to the first region based on the PSF; and generating a modified second region at least in part by applying a deconvolution operation to the second region based on the PSF.

Aspect 7: The method of any of Aspects 1 to 6, wherein the first object is a face of a first person and the second object of a face of a second person.

Aspect 8: The method of any of Aspects 1 to 7, wherein identifying the focal point at least in part using the first distance and the second distance comprises: determining a first depth of field associated with the first object and a second depth of field associated with the second object; and identifying the focal point as a point between the first depth of field and the second depth of field.

Aspect 9: The method of Aspect 8, wherein the first depth of field is determined using a lookup table based on a depth associated with the first object, and wherein the second depth of field is determined using the lookup table based on a depth associated with the second object.

Aspect 10: A non-transitory computer-readable medium of a network entity having stored thereon instructions that, when executed by one or more processors, cause the one or more processors to perform operations according to any of Aspects 1 to 9.

Aspect 11: An apparatus for wireless communications comprising one or more means for performing operations according to any of Aspects 1 to 9.

Aspect 12: A method for capturing an image, comprising: identifying a focal point of an object; capturing a first image using the focal point as a basis for the capture, the first image including a first region that is degraded due to an optical deformation; estimating a PSF based on the focal point and the optical deformation; and generating a second image from the first image at least in part by enhancing the first region of the first image using the PSF. In some aspects, the blurring can be caused by a distortion and the PSF can be estimated to enhance the image caused by that distortion.

Aspect 13: The method of Aspect 12, further comprising: determining a type of the optical deformation based on the PSF, wherein the type of deformation includes at least one of aberration associated with an optical setting, motion of the object, or a tilt. In some aspects, the blurring can be caused by a distortion associated various types of optical deformation and the PSF can be estimated to enhance the image.

Aspect 14: The method of any of Aspects 12 to 13, wherein generating of the second image from the first image at least in part by enhancing the first region comprises: enhancing the first region based on a determined motion of the object corresponding the PSF.

Aspect 15: The method of any of Aspects 12 to 14, wherein generating of the second image from the first image at least in part by enhancing the first region comprises: enhancing the first region of the first image based on a tilt and a center point of the tilt; and enhancing a second region of the first image based on the tilt and the center point.

Aspect 16: The method of any of Aspects 12 to 15, wherein generating of the second image from the first image at least in part by enhancing the first region comprises: enhancing the first region of the first image based on an optical setting used for capturing the first image, wherein the optical setting includes one of a type of lens or an aperture size of the lens.

Aspect 17: A non-transitory computer-readable medium of a network entity having stored thereon instructions that, when executed by one or more processors, cause the one or more processors to perform operations according to any of Aspects 12 to 16.

Aspect 18: An apparatus for wireless communications comprising one or more means for performing operations according to any of Aspects 12 to 16.

Aspect 19: An apparatus for capturing an image. The apparatus includes at least one memory (e.g., implemented in circuitry) and at least one processor (e.g., a single processor or multiple processors) coupled to the at least one memory. The at least one processor is configured to: determine, based on a depth map of a previously captured image, a first distance to a first object and a second distance to a second object; identify a focal point of a camera lens at least in part using the first distance and the second distance; capture an image using the focal point as a basis for the capture, the image including a first region corresponding to the first object and a second region corresponding to the second object; and generate a second image from the image at least in part by enhancing at least one of the first region or the second region using a PSF.

Aspect 20: The apparatus of Aspect 19, wherein the at least one processor is configured to: select the PSF based on at least one of a distance between the first object and the focal point and distance between the second object and the focal point.

Aspect 21: The apparatus of any of Aspects 19 or 20, wherein the PSF is selected from a lookup table.

Aspect 22: The apparatus of Aspect 21, wherein the lookup table is determined using a machine learning model trained using defocused images and a loss function to correct the defocused images.

Aspect 23: The apparatus of any of Aspects 21 or 22, wherein the lookup table is determined using a computer vision-based PSF estimate determined from defocused images and an error calculation and iteratively modifying the computer vision-based PSF estimate until a minimum error is identified for each focal distance and each amount of blur.

Aspect 24: The apparatus of any of Aspects 19 to 23, wherein the at least one processor is configured to: generate a modified first region at least in part by applying a deconvolution operation to the first region based on the PSF; and generate a modified second region at least in part by applying a deconvolution operation to the second region based on the PSF.

Aspect 25: The apparatus of any of Aspects 19 to 24, wherein the first object is a face of a first person and the second object of a face of a second person.

Aspect 26: The apparatus of any of Aspects 19 to 25, wherein the at least one processor is configured to: determine a first depth of field associated with the first object and a second depth of field associated with the second object; and identify the focal point as a point between the first depth of field and the second depth of field.

Aspect 27: The apparatus of Aspect 25, wherein the first depth of field is determined using a lookup table based on a depth associated with the first object, and wherein the second depth of field is determined using the lookup table based on a depth associated with the second object.

Aspect 28: An apparatus for capturing an image. The apparatus includes at least one memory (e.g., implemented in circuitry) and at least one processor (e.g., a single processor or multiple processors) coupled to the at least one memory. The at least one processor is configured to: identify a focal point of an object; capture a first image using the focal point as a basis for the capture, the first image including a first region that is degraded due to an optical deformation; estimate a PSF based on the focal point and the optical deformation; and generate a second image from the first image at least in part by enhancing the first region of the first image using the PSF. In some aspects, the blurring can be caused by various types of distortion and the PSF can be estimated to enhance the image caused by that distortion. In other aspects, a second region of the image may be enhanced using the PSF.

Aspect 29: The apparatus of Aspect 28, wherein the at least one processor is configured to: determine a type of the optical deformation based on the PSF, wherein the type of deformation includes at least one of aberration associated with an optical setting, motion of the object, or a tilt. In some aspects, the blurring can be caused by a distortion and the PSF can be estimated to enhance the image caused by that distortion.

Aspect 30: The apparatus of any of Aspects 28 to 29, wherein the at least one processor is configured to: enhance the first region based on a determined motion of the object corresponding the PSF.

Aspect 31: The apparatus of any of Aspects 28 to 30, wherein the at least one processor is configured to: enhance the first region of the first image based on a PSF tilt of a tilt and a center point of the tilt; and enhance a second region of the first image based on the tilt and the center point.

Aspect 32: The apparatus of any of Aspects 28 to 31, wherein the at least one processor is configured to: enhance the first region of the first image based on an optical setting used for capturing the first image, wherein the optical setting includes one of a type of lens or an aperture size of the lens.

What is claimed is:

1. A method for capturing an image, comprising:
determining, based on a depth map of a previously captured image, a first distance to a first object and a second distance to a second object;
identifying a focal point of a camera lens at least in part using the first distance and the second distance;
capturing an image using the focal point as a basis for the capture, the image including a first region corresponding to the first object and a second region corresponding to the second object; and
generating a second image from the image at least in part by enhancing at least one of the first region or the second region using a point spread function (PSF).

2. The method of claim 1, further comprising:
selecting the PSF based on at least one of a distance between the first object and the focal point and distance between the second object and the focal point.

3. The method of claim 2, wherein the PSF is selected from a lookup table.

4. The method of claim 3, wherein the lookup table is determined using a machine learning (ML) model trained using defocused images and a loss function to correct the defocused images.

5. The method of claim 4, wherein the lookup table is determined using a computer vision-based PSF estimate determined from defocused images and an error calculation and iteratively modifying the computer vision-based PSF estimate until a minimum error is identified for each focal distance and each amount of blur.

6. The method of claim 1, wherein enhancing at least one of the first region or the second region based on the PSF comprises:
generating a modified first region at least in part by applying a deconvolution operation to the first region based on the PSF; and
generating a modified second region at least in part by applying a deconvolution operation to the second region based on the PSF.

7. The method of claim 1, wherein the first object is a face of a first person and the second object of a face of a second person.

8. The method of claim 1, wherein identifying the focal point at least in part using the first distance and the second distance comprises:
determining a first depth of field associated with the first object and a second depth of field associated with the second object; and
identifying the focal point as a point between the first depth of field and the second depth of field.

9. The method of claim 8, wherein the first depth of field is determined using a lookup table based on a depth associated with the first object, and wherein the second depth of field is determined using the lookup table based on a depth associated with the second object.

10. A method for capturing an image, comprising:
identifying a focal point of an object;
capturing a first image using the focal point as a basis for the capture, the first image including a first region that is degraded due to an optical deformation;
estimating a point spread function (PSF) based on the focal point and the optical deformation; and
generating a second image from the first image at least in part by enhancing the first region of the first image using the PSF.

11. The method of claim 10, further comprising:
determining a type of the optical deformation based on the PSF, wherein the type of deformation includes at least one of aberration associated with an optical setting, motion of the object, or a tilt.

12. The method of claim 10, wherein generating of the second image from the first image at least in part by enhancing the first region comprises:
enhancing the first region based on a determined motion of the object corresponding the PSF.

13. The method of claim 10, wherein generating of the second image from the first image at least in part by enhancing the first region comprises:
enhancing the first region of the first image based on a tilt PSF associated with a tilt and a center point of the tilt; and
enhancing a second region of the first image based on the tilt PSF associated with the tilt and the center point.

14. The method of claim 10, wherein generating of the second image from the first image at least in part by enhancing the first region comprises:
enhancing the first region of the first image based on an optical setting used for capturing the first image, wherein the optical setting includes one of a type of lens or an aperture size of the lens.

15. An apparatus for capturing an image, comprising:
at least one memory; and
at least one processor coupled to the at least one memory and configured to:
determining, based on a depth map of a previously captured image, a first distance to a first object and a second distance to a second object;
identify a focal point of a camera lens at least in part using the first distance and the second distance;
capture an image using the focal point as a basis for the capture, the image including a first region corresponding to the first object and a second region corresponding to the second object; and
generate a second image from the image at least in part by enhancing at least one of the first region or the second region using a point spread function (PSF).

16. The apparatus of claim 15, wherein the at least one processor is configured to:
select the PSF based on at least one of a distance between the first object and the focal point and distance between the second object and the focal point.

17. The apparatus of claim 16, the PSF is selected from a lookup table.

18. The apparatus of claim 17, the lookup table is determined using a machine learning (ML) model trained using defocused images and a loss function to correct the defocused images.

19. The apparatus of claim 18, the lookup table is determined using a computer vision-based PSF estimate determined from defocused images and an error calculation and iteratively modifying the computer vision-based PSF estimate until a minimum error is identified for each focal distance and each amount of blur.

20. The apparatus of claim 15, wherein the at least one processor is configured to:
generate a modified first region at least in part by applying a deconvolution operation to the first region based on the PSF; and
generate a modified second region at least in part by applying a deconvolution operation to the second region based on the PSF.

21. The apparatus of claim 15, the first object is a face of a first person and the second object of a face of a second person.

22. The apparatus of claim 15, wherein the at least one processor is configured to:
determine a first depth of field associated with the first object and a second depth of field associated with the second object; and
identify the focal point as a point between the first depth of field and the second depth of field.

23. The apparatus of claim 22, the first depth of field is determined using a lookup table based on a depth associated with the first object, and wherein the second depth of field is determined using the lookup table based on a depth associated with the second object.

24. An apparatus for capturing an image, comprising:
at least one memory; and
at least one processor coupled to the at least one memory and configured to:
identify a focal point of an object;
capture a first image using the focal point as a basis for the capture, the first image including a first region that is blurred due to an optical deformation;
estimate a point spread function (PSF) based on the focal point and the optical deformation; and
generate a second image from the first image at least in part by enhancing the first region of the first image using the PSF.

25. The apparatus of claim 24, wherein the at least one processor is configured to:
determine a type of the optical deformation based on the PSF, wherein the type of deformation includes at least one of aberration associated with an optical setting, motion of the object, or a tilt.

26. The apparatus of claim 24, wherein the at least one processor is configured to:
enhance the first region based on a determined motion of the object corresponding the PSF.

27. The apparatus of claim 24, wherein the at least one processor is configured to:
enhance the first region of the first image based on tilt PSF associated with a tilt and a center point of the tilt; and
enhance a second region of the first image based on the tilt PSF associated the tilt and the center point.

28. The apparatus of claim 24, wherein the at least one processor is configured to:
enhance the first region of the first image based on an optical setting used for capturing the first image, wherein the optical setting includes one of a type of lens or an aperture size of the lens.
